(19) United States
(12) Patent Application Publication
(10) Pub. No.: US 2026/0008136 A1
(43) Pub. Date: Jan. 8, 2026

(54) POSITIONER

(71) Applicant: FANUC CORPORATION, Yamanashi (JP)

(72) Inventor: Tooru NAGAI, Yamanashi (JP)

(73) Assignee: FANUC CORPORATION, Yamanashi (JP)

(21) Appl. No.: 18/881,822

(22) PCT Filed: Oct. 3, 2022
(86) PCT No.: PCT/JP2022/036955

§ 371 Date: Jan. 7, 2025

(51) Int. Cl. B23K 37/04

(52) U.S. Cl. CPC B23K 37/0461

(57) ABSTRACT

A positioner includes: a base having a pair of support parts disposed with a prescribed gap therebetween in a direction of first axis; a shaft member disposed between the pair of support parts and is supported so as to be rotatable about the first axis relative to the base; and a disc-shaped rotary table supported to be rotatable about a second axis orthogonal to the first axis relative to the shaft member and having a mounting surface where a workpiece can be mounted, The rotary table has an outer diameter dimension that fits inward of both ends of the shaft member in the direction of the first axis, and in a movable range of the rotary table about the first axis.

### TECHNICAL FIELD

The present disclosure relates to a positioner.

### BACKGROUND

There is a known rotary table device capable of changing the orientation of a supported workpiece about two axes by rotating the workpiece about a tilt axis extending in the horizontal direction and a rotation axis orthogonal to the tilt axis (for example, see Japanese Unexamined Utility Model Application, Publication No. H06-000625).

The rotary table device includes: a rotary table to which a workpiece is fixed and that rotates the workpiece about the rotation axis; and a tilt table that supports the rotary table so as to be rotatable about the tilt axis.

### SUMMARY

According to one aspect, the present disclosure provides a positioner including: a base having a pair of support parts disposed with a prescribed gap therebetween in a direction of a first axis; a shaft member that is disposed between the pair of support parts and that is supported so as to be rotatable about the first axis relative to the base; and a disc-shaped rotary table that is supported so as to be rotatable about a second axis orthogonal to the first axis relative to the shaft member and that has a mounting surface on which a workpiece can be mounted, wherein the rotary table has an outer diameter dimension that fits inward of both ends of the shaft member in the direction of the first axis, and in a movable range of the rotary table about the first axis, a distance of the mounting surface from the first axis is set to be greater than a distance of an outermost edge about the first axis of at least one of the support parts from the first axis, and a distance of a rear surface of the mounting surface of the rotary table from the first axis is set to be less than the distance of the outermost edge from the first axis.

### BRIEF DESCRIPTION OF DRAWINGS

FIG. 1 is a perspective view showing the outline of a positioner according to one embodiment of the present disclosure.

FIG. 2 is a longitudinal sectional view of the positioner shown in FIG. 1.

FIG. 3 is a side view of the positioner shown in FIG. 1.

FIG. 4 is a side view showing a state in which a shaft member of the positioner shown in FIG. 3 has been rotated by 90° about a first axis.

FIG. 5 is a view of the shaft member of the positioner shown in FIG. 1, viewed from a back surface side opposite to a rotary table.

FIG. 6 is a longitudinal sectional view showing a modification of the positioner shown in FIG. 1.

### DETAILED DESCRIPTION OF EMBODIMENTS

A positioner 10 according to one embodiment of the present disclosure will be described below with reference to the drawings.

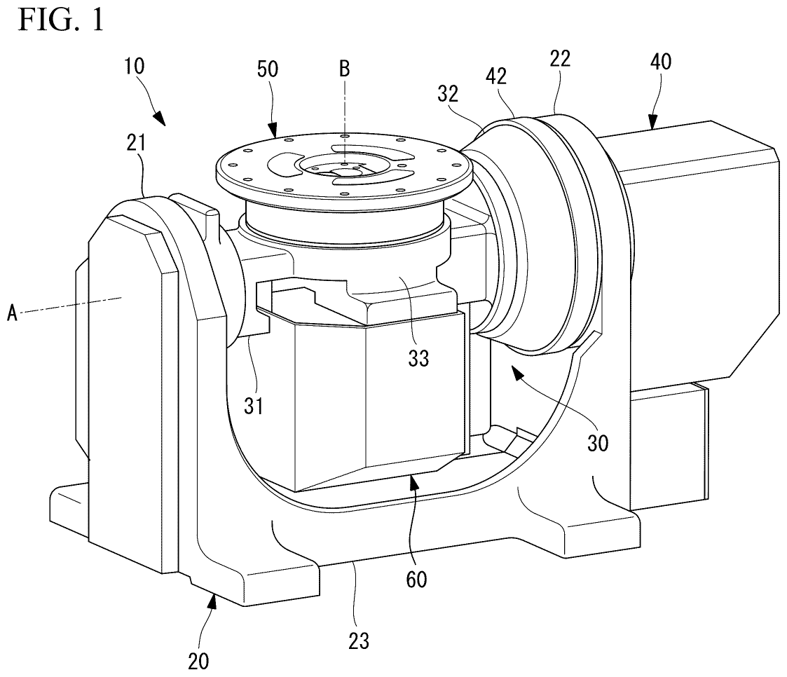

As shown in FIG. 1, the positioner 10 of this embodiment includes, for example, a base 20 that is installed on a horizontal installation surface, such as a floor surface, and a shaft member 30 that is supported so as to be rotatable about a horizontal first axis A relative to the base 20. Furthermore, the positioner 10 includes a first drive mechanism 40 that rotates the shaft member 30 about the first axis A relative to the base 20.

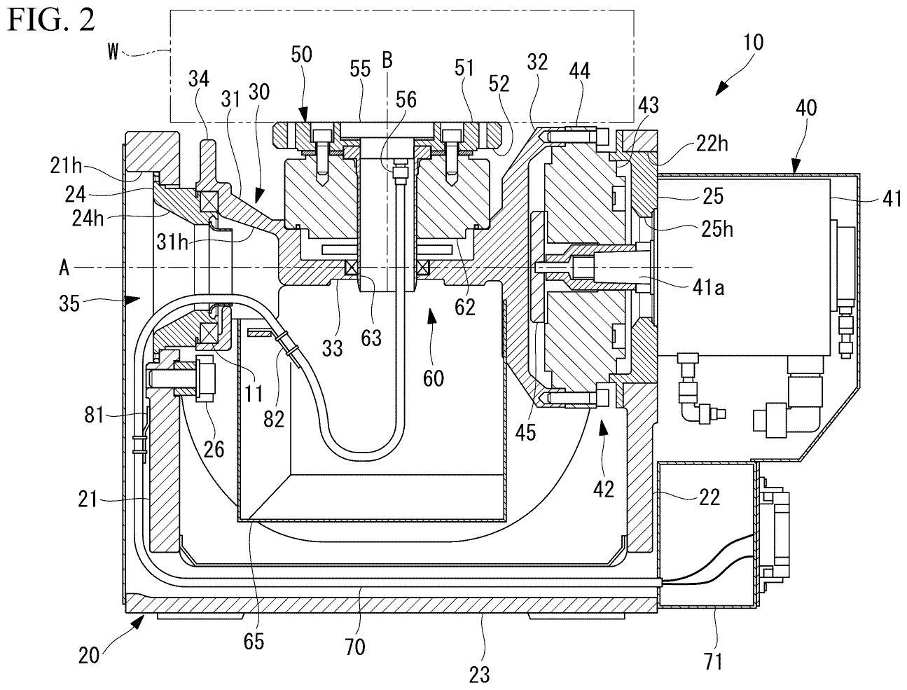

The positioner 10 further includes: a rotary table 50 that is supported so as to be rotatable about a second axis B orthogonal to the first axis A, relative to the shaft member 30; and a second drive mechanism 60 that rotationally drives the rotary table 50. Furthermore, the positioner 10 includes a power cable 70 for connecting the rotary table 50 and an external power supply (not shown), as shown in FIG. 2.

The base 20 includes a bottom part 23 that is placed on the installation surface and flat plate-like support parts 21 and 22 that individually protrude upward from the bottom part 23.

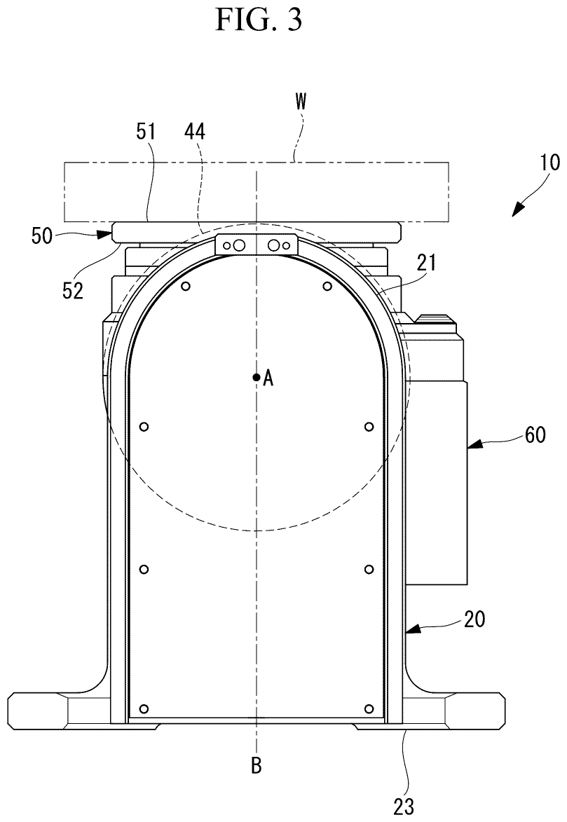

The support parts 21 and 22 are disposed in parallel to each other with a gap therebetween in the direction of the first axis A. Upper end surfaces of the support parts 21 and 22 have cylindrical external shapes centered on the first axis A, as shown in FIG. 3.

Furthermore, the support parts 21 and 22 have, therein, through holes 21h and 22h respectively penetrating through the support parts 21 and 22 along the first axis A, as shown in FIG. 2.

The base 20 includes sleeves 24 and 25 that are respectively fitted into the through holes 21h and 22h. The sleeves 24 and 25 respectively have inner holes 24h and 25h provided therein.

As shown in FIG. 2, the shaft member 30 is a shaft-shaped member having a longitudinal axis and includes end parts 31 and 32 at both sides in the longitudinal-axis direction and a center part 33 disposed between the end parts 31 and 32.

The end part 31 is supported so as to be rotatable about the first axis A relative to the sleeve 24. Furthermore, the end part 32 is supported so as to be rotatable about the first axis A relative to the sleeve 25, by a first reducer (reducer) 42, to be described later, attached between the sleeve 25 and the end part 32. Accordingly, the shaft member 30 is supported in a manner of double sided beam between the support parts 21 and 22, with the longitudinal axis thereof being aligned with the first axis A.

Outer diameter dimensions of the end parts 31 and 32 about the first axis A are set to be greater than an outer diameter dimension of the center part 33 about the first axis A, as shown in FIG. 2, for example. Furthermore, the end part 31 includes, at a position in the circumferential direction of the second axis B, a protrusion 34 formed by making a part of an outer circumferential surface of the end part 31 protrude radially outward. On the end part 31 side, a tip end surface of the protrusion 34 is positioned at the outermost edge of the shaft member 30 about the first axis A.

Furthermore, when the shaft member 30 is rotated beyond a predetermined angle, for example, ±90°, about the first axis A from the position where the second axis B is disposed in the vertical direction, the protrusion 34 abuts against a stopper 26 provided on the support part 21. Accordingly, the protrusion 34 and the stopper 26 regulate the operating range of the shaft member 30 to ±90°.

Furthermore, the end part 31 has, therein, a hollow portion (first hollow portion) 31h extending from an end surface thereof along the first axis A. The sleeve 24 is inserted into the hollow portion 31h from the end surface side, and a bearing 11 is disposed between an outer circumferential surface of the sleeve 24 and an inner circumferential surface of the hollow portion 31h. Accordingly, the end part 31 is supported so as to be rotatable about the first axis A relative to the sleeve 24.

Furthermore, the hollow portion 31h is open to the opposite side from the rotary table 50 (hereinafter, also referred to as back surface side), at a section closer to the center part 33 than a section supported by the bearing 11 is. Accordingly, a hollow path 35 is formed, which passes from an outer side of the support part 21 in the direction of the first axis A to a back surface side of the shaft member 30 through the inner hole 24h of the sleeve 24 and the hollow portion 31h.

The center part 33 has a shape depressed toward the first axis A along the second axis B and has a cylindrical inner surface about the second axis B.

The first drive mechanism 40 includes: a first motor 41 fixed to the support part 22 of the base 20; and the first reducer 42, by which the rotation of a motor shaft 41a of the first motor 41 is decelerated and transmitted to the shaft member 30. The first motor 41 is fixed to an outer surface of the sleeve 25, which is fitted into the through hole 22h of the support part 22. The motor shaft 41a of the first motor 41 penetrates through the inner hole 25h of the sleeve 25 from the outside and is disposed along the first axis A.

The first reducer 42 includes a fixed part 43 fixed to an inner surface of the sleeve 25 and an output part 44 made to rotate about the first axis A relative to the fixed part 43. A plurality of gears (not shown) including a gear engaged with a gear 45 fixed to the motor shaft 41a are accommodated inside the first reducer 42. The output part 44 is fixed to an end surface of the end part 32 of the shaft member 30. Accordingly, the rotation of the motor shaft 41a of the first motor 41 is decelerated and transmitted to the end part 32 by the first reducer 42.

On the end part 32 side, an outer circumferential surface of the output part 44 is the outermost edge of the first reducer 42 about the first axis A. Furthermore, the outer circumferential surface of the output part 44 is disposed further outward, in the radial direction centered on the first axis A, than upper end surfaces of the support parts 21 and 22 and the tip end surface of the protrusion 34 of the shaft member 30.

That is, the outer circumferential surface of the output part 44 is positioned at the outermost edge of the first reducer 42, the shaft member 30, and the base 20 about the first axis A.

The rotary table 50 is formed of a conductive material into a disc shape and includes a mounting surface 51 on which a workpiece W is mounted. The rotary table 50 is disposed at a position where the central axis thereof is aligned with the second axis B, and is supported so as to be rotatable about the second axis B relative to the shaft member 30 by a second reducer 62, to be described later.

Furthermore, as shown in FIG. 2, an outer diameter dimension of the rotary table 50 is set to a size that is accommodated further inward, in the direction along the first axis A, than the end parts 31 and 32. That is, the rotary table 50 is disposed at a position where the rotary table 50 does not overlap with the end parts 31 and 32 in the direction along the first axis A.

Furthermore, the distance of the mounting surface 51 of the rotary table 50 from the first axis A is set to be slightly greater than the outer diameter dimension of the outer circumferential surface of the output part 44.

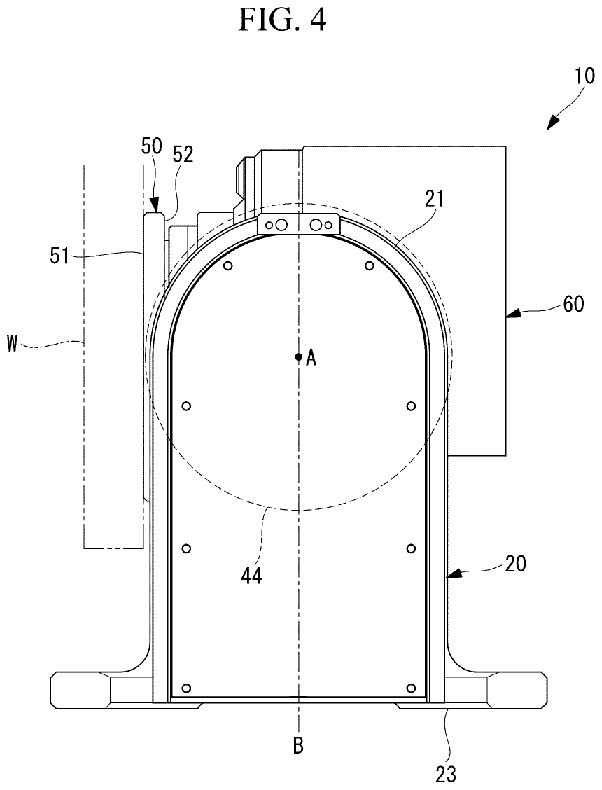

On the other hand, the distance of a rear surface 52 of the rotary table 50 from the first axis A is set to be less than the outer diameter dimension of the outer circumferential surface of the output part 44, as shown in FIGS. 3 and 4.

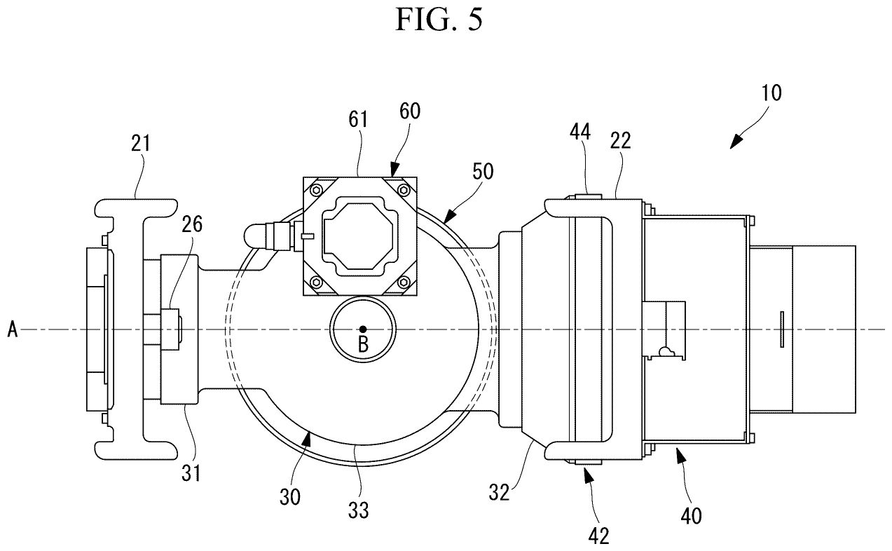

As shown in FIG. 5, the second drive mechanism 60 includes a second motor 61 fixed to the shaft member 30, at a position offset in parallel relative to the second axis B. Furthermore, as shown in FIG. 2, the second drive mechanism 60 includes the second reducer 62, by which the rotation of a motor shaft (not shown) of the second motor 61 is decelerated and transmitted to the rotary table 50. Furthermore, the second drive mechanism 60 includes a protection cover 65 that is fixed to the shaft member 30 and that surrounds the second motor 61.

The second reducer 62 is disposed between the center part 33 of the shaft member 30 and the rotary table 50. Furthermore, the second reducer 62 is fixed to the center part 33 and decelerates and transmits the rotation of the motor shaft of the second motor 61 to the rotary table 50, thereby rotating the rotary table 50 about the second axis B relative to the shaft member 30.

Furthermore, the rotary table 50, the second reducer 62, and the center part 33 of the shaft member 30 have, in a region including the second axis B, a hollow portion (second hollow portion) 63 penetrating therethrough along the second axis B. One end of the hollow portion 63 in the direction of the second axis B is open to the side of the mounting surface 51 of the rotary table 50, and the other end thereof is open to the back surface side of the shaft member 30.

In the opening of the hollow portion 63 on the rotary table 50 side, an adapter 55 formed of a conductive material is fixed, at the position where the opening is closed, so as to be detachable from the mounting surface 51 side, as shown in FIG. 2. A terminal 56 to which the power cable 70 is connected is provided on the adapter 55.

One end of the power cable 70 is connected to the terminal 56 of the adapter 55, and the other end thereof is connected to an electricity distribution box 71 installed on a side surface of the support part 22. Accordingly, when the electricity distribution box 71 is connected to an external welding power supply (power supply) (not shown), for example, the rotary table 50 is connected to a negative electrode via the power cable 70 and the adapter 55.

The operation of the thus-configured positioner 10 of this embodiment will be described below.

For example, when arc welding is performed on the workpiece W by using a welding robot (not shown), first, the positioner 10 of this embodiment is installed at a predetermined position inside a work area of the welding robot. Then, the workpiece W is mounted on the mounting surface 51 of the rotary table 50 of the positioner 10.

Next, the electricity distribution box 71, which is fixed to the side surface of the support part 22 of the base 20, is connected to an external welding power supply. Accordingly, a negative electrode is connected to the workpiece W via the power cable 70, the adapter 55, and the rotary table 50. Furthermore, a welding torch fixed to a wrist tip of the welding robot is connected to a positive electrode of the welding power supply. Then, a tip of the welding torch is made to come close to a surface of the workpiece W with a predetermined distance therebetween, and the welding robot is operated. Accordingly, it is possible to generate an arc between the workpiece W and the welding torch to weld the workpiece W.

Furthermore, in this case, when the first motor 41 is operated, the rotation of the motor shaft 41a is decelerated and transmitted to the shaft member 30 by the first reducer 42. Then, the shaft member 30 is made to rotate about the first axis A relative to the base 20.

Furthermore, when the second motor 61 is operated, the rotation of the motor shaft of the second motor 61 is decelerated and transmitted to the rotary table 50 by the second reducer 62. As a result, the rotary table 50 is made to rotate about the second axis B relative to the shaft member 30.

Accordingly, the orientation of the workpiece W can be changed about the first axis A and the second axis B. That is, the position of the surface of the workpiece W, to which the tip of the welding torch comes close, can be changed about two axes, whereby a desired section of the workpiece W can be welded.

Furthermore, in this embodiment, the rotary table 50 is positioned so as not to overlap with the end parts 31 and 32 of the shaft member 30 in the direction along the first axis A. Thus, as shown in FIG. 3, a region of the rear surface 52 of the rotary table 50 in the vicinity of the central axis is made closer to the first axis A than the outer circumferential surface of the output part 44 is.

That is, the mounting surface 51 can be made to come close to the first axis A, compared with a case in which the entire rotary table 50 is disposed further outward, in the radial direction centered on the first axis A, than the outer circumferential surface of the output part 44. Accordingly, the workpiece W, which is a heavy object, mounted on the mounting surface 51 can be disposed close to the first axis A.

The workpiece W is made close to the first axis A, whereby, when the shaft member 30 is rotated about the first axis A, the rotational moment and inertia about the first axis A that act on the rotary table 50 can be reduced. As a result, it is possible to improve the accuracy of positioning of the workpiece W about the first axis A and to reduce the load acting on the motor shaft 41a of the first motor 41.

In this case, as shown in FIGS. 3 and 4, in the whole movable range of the rotary table 50 about the first axis A, the mounting surface 51 is always disposed further outward, in the radial direction centered on the first axis A, than the outer circumferential surface of the output part 44. That is, the first reducer 42, the shaft member 30, and the support parts 21 and 22 are not disposed on the movement route of the workpiece W mounted on the mounting surface 51. Accordingly, when the orientation of the workpiece W is changed about the first axis A, the workpiece W can be prevented from interfering with the components of the positioner 10.

In this way, according to this embodiment, the workpiece W mounted on the rotary table 50 can be made close to the first axis A while being disposed at a position where the workpiece W does not interfere with the positioner 10. That is, it is possible to reduce the rotational moment and inertia generated when the workpiece W is rotated about the first axis A, without limiting the size of the workpiece W mounted on the rotary table 50.

Furthermore, as shown in FIG. 2, the power cable 70 in this embodiment is guided from the electricity distribution box 71 to the outside of the support part 21 along the bottom part 23 of the base 20, for example. Then, the power cable 70 is fixed to the support part 21 by a first clamp 81 at a position where the power cable 70 is curved upward along the support part 21, and is then guided to the inside of the hollow path 35 from the outside of the support part 21.

The power cable 70 guided to the inside of the hollow path 35 extends in the hollow path 35 in the vicinity of the first axis A along the first axis A and is fixed to the shaft member 30 by a second clamp 82 at a position where the power cable 70 has passed through the hollow portion 31h of the shaft member 30.

After that, the power cable 70 is curved in a direction away from the rotary table 50 and is then curved by about 180° in a U-shape. Then, the power cable 70 extends along the second axis B, is guided to the inside of the hollow portion 63, and is detachably fixed to the terminal 56 at one end of the power cable 70, the terminal 56 being provided on the adapter 55.

In this case, when the shaft member 30 is rotated about the first axis A relative to the base 20, the relative position thereof with the first clamp 81 and the second clamp 82 about the first axis A is changed in accordance with the rotational movement. Thus, a section of the power cable 70 between the first clamp 81 and the second clamp 82 is twisted about the first axis A with a bending deformation about the first axis A. On the other hand, a section of the power cable 70 between the second clamp 82 and the terminal 56 is not deformed since it is rotated about the first axis A integrally with the shaft member 30.

Furthermore, when the rotary table 50 is rotated about the second axis B relative to the shaft member 30, a torsional force about the second axis B acts on the power cable 70. Thus, torsional deformation and bending deformation about the second axis B are generated in a U-shape extra-length section provided in the power cable 70 between the second clamp 82 and the terminal 56.

Furthermore, the torsional force about the second axis B acting on the power cable 70 due to the rotation of the rotary table 50 about the second axis B is blocked by the second clamp 82. Thus, a section of the power cable 70 that is closer to the first clamp 81 than the second clamp 82 is is prevented from being deformed.

With this wiring, a section of the power cable 70 that is deformed by the rotation of the shaft member 30 about the first axis A and a section thereof that is deformed by the rotation of the rotary table 50 about the second axis B can be made different.

Accordingly, even when the rotation of the shaft member 30 about the first axis A and the rotation of the rotary table 50 about the second axis B are executed at the same time, it is possible to prevent a situation in which movements of the sections of the power cable 70 are combined to make the power cable 70 shake a lot.

Furthermore, when the shaft member 30 and the rotary table 50 are rotated about the respective axes, not only torsional deformation but also bending deformation can be generated in the power cable 70. Accordingly, there is an advantage that a torsional force acting on the power cable 70 can be effectively absorbed.

Note that, in this embodiment, a configuration is shown in which the section of the power cable 70 between the second clamp 82 and the terminal 56 is deformed in accordance with the rotation of the rotary table 50 about the second axis B. Instead of this, it is also possible to adopt a configuration in which the orientation of the power cable 70 is maintained even when the rotary table 50 is rotated about the second axis B.

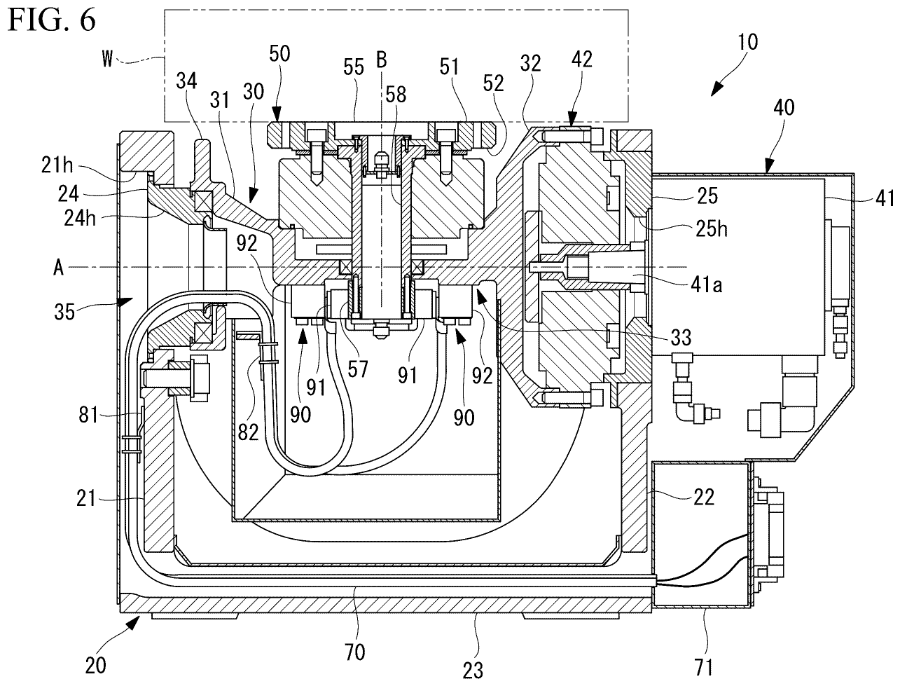

For example, as shown in FIG. 6, an adapter 55 equipped with a cylindrical shaft 57 formed of a conductive material and a rotary joint 58 attached to the shaft 57 is attached to the rotary table 50. Furthermore, current collecting brushes 90 are attached to the back side of the center part 33 of the shaft member 30 at two positions with a gap therebetween in the circumferential direction about the second axis B.

The current collecting brushes 90 each include a carbon brush part 91 and a pressing part 92 for pressing the brush part 91 against an outer circumferential surface of the shaft 57. Then, the pressing parts 92 are fixed to the back surface of the center part 33, whereby the pair of the brush parts 91 sandwich the outer circumferential surface of the shaft 57 from radially outer sides. In this case, tip ends of power cables 70 are connected to terminals (not shown) provided in the pair of the brush parts 91.

With this configuration, when the rotary table 50 is rotated about the second axis B, the shaft 57 is also rotated about the second axis B together with the rotary table 50. On the other hand, the current collecting brushes 90 are not rotated about the second axis B, whereby the contact state of the brush parts 91 and the outer circumferential surface of the shaft 57 is maintained.

Therefore, even when the rotary table 50 is endlessly rotated about the second axis B, it is possible to keep the rotary table 50 connected to the negative electrode while maintaining the orientations of the power cables 70. Furthermore, also when the shaft member 30 is rotated about the first axis A, only sections of the power cables 70 between the first clamp 81 and the second clamp 82 are deformed, and sections of the power cables 70 between the second clamp 82 and tip ends are prevented from being deformed.

Accordingly, it is possible to shorten extra-length sections of the power cables 70 between the second clamp 82 and the tip ends to minimum required lengths and to achieve shortening of the power cables 70 and miniaturization of the entire positioner 10.

Furthermore, in this embodiment, the outer circumferential surface of the output part 44 of the first reducer 42 is the outermost edge of the positioner 10 about the first axis A in the movable range of the rotary table 50. Instead of this, another component may be disposed at the outermost edge of the positioner 10 about the first axis A.

For example, the protrusion 34, which is provided in the end part 31 of the shaft member 30, may protrude further outward, in the radial direction centered on the first axis A, than the outer circumferential surface of the output part 44.

In this case, since a tip end surface of the protrusion 34 is the outermost edge of the positioner 10 about the first axis A, the mounting surface 51 just needs to be disposed slightly further outward, in the radial direction centered on the first axis A, than the tip end surface of the protrusion 34.

Accordingly, as in the above-described configuration, while the rotational moment and inertia about the first axis A are reduced, it is not necessary to limit the size of the workpiece W mounted on the rotary table 50.

Similarly, the upper end surfaces of the support parts 21 and 22 may also be disposed further outward, in the radial direction centered on first axis A, than the outer circumferential surface of the output part 44 and the tip end surface of the protrusion 34. In this case, the mounting surface 51 just needs to be disposed slightly further outward, in the radial direction centered on the first axis A, than the upper end surfaces of the support parts 21 and 22.

Furthermore, in this case, the upper end surfaces of the support parts 21 and 22 may also be formed into an exterior shape that is half a circumferential of a cylindrical surface centered on the first axis A and having a slightly shorter radius dimension than the distance from the first axis A to the mounting surface 51.

Furthermore, in this embodiment, an adapter member having a larger diameter than that of the rotary table 50 may be interposed between the mounting surface 51 of the rotary table 50 and the workpiece W. Accordingly, the workpiece W can be supported by a wider surface than the mounting surface 51 of the rotary table 50.

Furthermore, although the positioner 10 of this embodiment includes the power cable(s) 70 for connecting a negative electrode(s) to the rotary table 50, in addition to this, the positioner 10 may also include a pipe for supplying a fluid such as pressurized air to the rotary table 50.

In this case, the pipe for supplying a fluid to the rotary table 50 may be wired in the same route as the power cable(s) 70. Furthermore, this pipe may be fixed by the first clamp 81 and the second clamp 82 together with the power cable(s) 70.

Although the embodiments of the present disclosure have been described above in detail, the present disclosure is not limited to the above-described individual embodiments. In these embodiments, various additions, replacements, modifications, and partial eliminations can be made without departing from the scope of the invention or without departing from the idea and the gist of the present invention derived from the content stated in the scope of claims and the equivalent thereof. For example, in the above-described embodiments, the order of operations and the order of processing procedures are shown as examples, and the present disclosure is not limited thereto.

1. A positioner comprising:
a base having a pair of support parts disposed with a prescribed gap therebetween in a direction of a first axis;
a shaft member that is disposed between the pair of support parts and that is supported so as to be rotatable about the first axis relative to the base; and
a disc-shaped rotary table that is supported so as to be rotatable about a second axis orthogonal to the first axis relative to the shaft member and that has a mounting surface on which a workpiece can be mounted,
wherein the rotary table has an outer diameter dimension that fits inward of both ends of the shaft member in the direction of the first axis, and
in a movable range of the rotary table about the first axis, a distance of the mounting surface from the first axis is set to be greater than a distance of an outermost edge about the first axis of at least one of the support parts from the first axis, and a distance of a rear surface of the mounting surface of the rotary table from the first axis is set to be less than the distance of the outermost edge from the first axis.

2. The positioner according to claim 1, further comprising, between one of the support parts and one of end parts of the shaft member, a reducer that supports the shaft member so as to be rotatable about the first axis relative to the one of the support parts,
wherein distances of outer surfaces of the shaft member and the reducer in a direction of the second axis from the first axis are set to be less than the distance of the mounting surface from the first axis, and the distance of the rear surface from the first axis is set to be less than the distances of the outer surfaces from the first axis.

3. The positioner according to claim 1, wherein a part of an outer circumferential surface of at least one of the support parts about the first axis is formed of a cylindrical surface about the first axis.

4. The positioner according to claim 1, further comprising:
a power cable that connects the rotary table and an external power supply; and
a second reducer that connects the shaft member and the rotary table so as to allow relative rotation about the second axis,
wherein one of the support parts has a through hole penetrating therethrough along the first axis,
the shaft member has a first hollow portion communicating with the through hole,
the second reducer has a second hollow portion extending along the second axis, and
the power cable is guided toward the first axis along the one of the support parts, is fixed to an outer surface of the one of the support parts by a first clamp, is guided to an inside of the first hollow portion via the through hole, is fixed to the shaft member by a second clamp at a position where the power cable is curved in a direction away from the rotary table, is then curved while having an extra length, is made to pass through the second hollow portion along the second axis, and is connected to the rotary table at one end of the power cable.
